(19) United States
(12) Patent Application Publication
(10) Pub. No.: US 2005/0123785 A1
(43) Pub. Date: Jun. 9, 2005

(54) High temperature clearance coating

(76) Inventors: Purusottam Sahoo, Sugar Land, TX (US); Shane M. Richard, Deer Park, TX (US); Cyril Stephen Magda JR., Magnolia, TX (US)

Correspondence Address: Francis C. Hand, Esq.;c/o Carella, Byrne, Bain, Gilfillan, Cecchi, Stewart & Olstein, 5 Becker Farm Road, Roseland, NJ, 07068, US

(21) Appl. No.: 10/728,014

(22) Filed: Dec. 4, 2003

(51) Int. Cl. B32B 15/10

(52) U.S. Cl. 428/655; 428/651; 428/650

(57) ABSTRACT

A thermal barrier coating with abradable properties suitable for high temperature clearance control on a sealing surface is provided. The coating is thermally sprayed, consisting of a MCrAlY bond coat and a top coat of yttria stabilized zirconia containing polyester. The two layer coating is deposited using an air plasma spray system with suitable porosity levels to enable the ceramic top coat to have properties suitable for advanced gas turbine shroud block sealing purposes. This coating for sealing purposes is applicable to both industrial and flight gas turbine applications.

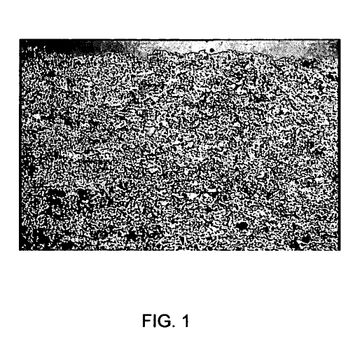

The invention relates to a high temperature clearance coating. More particularly, this invention relates to a thermally insulative coating for a gas turbine. Still more particularly, this invention relates to an abradable thermal barrier for a shroud block in a gas turbine.

### BACKGROUND OF THE INVENTION

In order to increase the efficiency of gas turbines, the firing temperature must be increased. Current advanced technology heavy frame gas turbines (i.e., GE Frame FA and beyond; Siemens-Westinghouse 501G and beyond) are operating at temperatures well above the design limits of many alloys. This is possible only because thermal barrier coatings (TBC) are applied onto the gas path surfaces that are exposed to high temperatures. Typically, the highest temperatures in a gas turbine occur in the turbine section where rotating blades (sometimes called “buckets”) spin at high rpm against a “shroud” supported by an engine case.

In order to enhance efficiency and minimize leakage losses, the clearance between the rotating parts and the stationary shroud is kept to a minimum. In gas turbines, the blades in the front stages rub against a sealing surface, called an inner shroud plate or something similar, and “cut” a sealing path. Shrouds provide a rubbing surface for the tip of the blade. The shroud thus is exposed to abrasion wear from the rotating blade tip. In advanced technology turbines, these shroud plates are coated to insulate the plate from overheating. Since the coating is rubbed by the buckets, the coating must abrade relatively easier than the blade tips else leaks will occur. In addition, the blade tip is considered a crucial part and thus wear should be minimized.

In order to insulate the shroud plate, the coating is typically made of thermally sprayed zirconia-yttria powder. In addition, to enable the blade tip not to wear rapidly, the ceramic coating must abrade with respect to the blade tip material.

An analogous situation exists in flight gas turbine engines. For example, in high-bypass turbofan engines (colloquially called jet engines); a similar part would be called an outer air seal, outer shroud segment, or some such similar term(s). The three main global manufacturers of jet engines are: General Electric, Rolls-Royce, and Pratt & Whitney. All three may use slightly different terminology to denote the same part or combination of parts. In any event, the primary purpose is still the same, i.e. to increase efficiency by minimizing leaks between a rotating member and a stationary sealing surface.

Typically, the blade rotates about a central axis and the tip of the blade rubs against a shroud, the face of which is coated with the coating. The shrouds are arranged in a fashion so as to form an annular cylinder about the rotating blades. The blades rotate at very high rpm (several thousand to many thousand rpm) because of the expansion of hot gases being forced through the passageways between the blades. The coated surface of the shroud is utilized to minimize leaks and thus improve efficiency of the gas turbine.

It is known in the art of gas turbine coatings that the desirable properties of a coating are dependent on a variety of factors, including chemical composition, method of application, coating porosity, thickness of the coating, and the existence of cracks (microcracks and macrocracks) in the deposited coating layer(s). The insulative property (i.e., the reduction of temperature) is linearly dependent on the thickness of the coating, all other factors remaining the same. In addition, the thermal insulation is a function of the coating microstructure. Typically, for thermal insulation applications, zirconia based coatings (colloquially called YSZ: Yttria partially Stabilized Zirconia) have been used for decades. There are other compositions that are continually being researched and tested as alternatives to YSZ. In actual production, however, there have been very few alternates to this coating. However, if such a composition is found, the findings of this will be applicable to these new compositions.

In advanced gas turbines, the designer needs more than an insulative coating. In addition, the coating must be cost effective in a production mode and compatible with the rotating member.

Various coatings and techniques of applying coatings are known. For example, U.S. Pat. No. 4,299,865 describes a method of applying a NiCrAlY bond and a zirconia coating containing polyester that is to be heat treated at 1800° F. for 4 hours. However, the described process calls for a co-deposition of two different powders using two separate feeding mechanisms. This makes the process complicated and unreliable and adds cost to the process. Further, the ceramic coating has more than one layer. Again, this complicates the process and may be unreliable in production. In addition, the application of multiple coatings will raise production costs. Still further, the bond coat is a NiCrAlY coating, which coating is not suitable for the high temperature regime expected in advanced turbines. Also, the process refers to applications in the compressor section that is at a much lower temperature than the turbine section in a gas turbine.

U.S. Pat. No. 5,352,540 describes a strain tolerant coating consisting of multiple ceramic layers, some containing a lubricant.

U.S. Pat. No. 5,530,050 describes a method of preparing powders suitable for high temperature applications. This powder contains ceramic particles that are attrition milled with plastic core particles.

U.S. Pat. No. 5,704,759 describes an abradable coating made of zirconia treated with a boron nitride composited polyester. U.S. Pat. No. 5,536,022 describes another abradable coating containing hexagonal boron nitride. U.S. Pat. No. 5,705,231 describes the formation of a complex segmented abradable coating.

U.S. Pat. No. 5,780,116 describes the application of a superalloy containing low-porosity abradable coating.

U.S. Pat. No. 6,102,656 describes the application of an abradable coating with erosion resistant properties.

U.S. Pat. No. 6,224,963 describes the formation of a zirconia thermal barrier coating (TBC) with grooves formed by a laser.

U.S. Pat. No. 6,235,370 describes the application of a honeycomb structure thermal barrier coating (TBC).

U.S. Pat. No. 6,254,700 describes the application of an abradable coating made of a quasicrystalline material. U.S. Pat. No. 6,352,264 describes the application of an abradable coating consisting of thermosetting polymer and a thermoplastic polymer.

U.S. Pat. No. 6,356,222 describes the application of an abradable coating applied via a cold spray method. U.S. Pat. No. 6,533,285 describes a sealing mechanism using quasicrystalline material and silicon. U.S. Pat. No. 6,541,134 describes an abradable coating on a ceramic substrate.

Previous techniques have employed rather complex methods to produce coatings that provide one or the other benefits of such a coating: either thermally insulative property, or abradability property. Using a statistical approach to spraying the coating allows a coating with the dual beneficial properties to be applied at a cost that is reasonable.

Accordingly, it is an object of the invention to provide a high temperature abradable coating that can be used between the rotating parts of a gas turbine and a stationary case.

It is another object of the invention to use standard spray equipment for applying a high temperature abradable coating to a substrate.

It is another object of the invention to provide an economical thermally insulative coating for a gas turbine.

Briefly, the invention provides a spray process that uses a standard plasma spray gun and commercially available powders for a coating that has the desirable properties of being both a thermal insulator and being abradable.

The invention also provides a coated substrate comprising a substrate, a bond coat on the substrate comprised of a high temperature MCrAlY coating of a thickness of from 0.003 inches to 0.015 inches, preferably from 0.007 to 0.012 inch; and an abradable top coat on the bond coat comprised of high temperature yttria stabilized zirconia of a thickness of from 0.012 inches to 0.080 inch, preferably between 0.025 to 0.060 inch.

The MCrAlY coating is preferably NiCoCrAlY wherein M is any one of Nickel (Ni), Cobalt (Co) or Iron (Fe) or combinations thereof. However, those skilled in the art will realize that there are other types of MCrAlY coatings that can be effectively used. Examples of such coatings are found in U.S. Pat. No. 4,585,481 that describes a NiCoCrAlY+Hf+Si coating. The additions of other elements, such as hafnium and silicon, are sometimes called reactive element additions. These help in resisting oxidation and improve the life of the bond coat.

The top coat may also include a polyester in order to increase the amount of porosity in the coating. This is an advantage for coatings that need abradability. The actual amount of polyester depends on the chemical type of polyester and the application intended for the coating. The amount of polyester is in an amount of from 3% to 9% by weight and preferably from 4% to 6% by weight.

These and other objects and advantages of the invention will become more apparent from the following detailed description taken with the accompanying drawing wherein:

The drawing is a photomicrograph of the cross-section of a coating in accordance with the invention.

In order to have the appropriate and desired microstructure, a series of designed experiments (DOE) were run. The purpose of a DOE (Design of Experiment) is to determine coating properties (e.g., porosity) and their trends as a function of spray parameters (e.g., amperage). Using this approach, a statistically significant process optimization can be conducted. In a process, such as a thermal spray process in which interaction effects can be significant, the results can sometimes be counter-intuitive. It has been found that using such an approach, a more reliable and robust process may be discovered.

The bond coat was selected to be a high temperature MCrAlY (commercial brands such as Metco 9954 or 365) such as a NiCoCrAlY. A specification sheet regarding a commercially available AMDRY 9954 powder is attached as Exhibit 1 and a material certification of the commercially available AMDRY 365-2 powder is attached as Exhibit 2.

Unlike the bond coat in U.S. Pat. No. 4,299,865 which uses a NiCrAlY bond coat, the present bond coat utilizes a NiCoCrAlY. To those skilled in the art, the new MCrAlY will tolerate much higher temperatures.

The bond thickness is also proposed to be thicker for this particular application. Since oxidation is a time and temperature dependent phenomenon, the thicker the coating, the longer the expected useful life. Since these parts are expected to see very high temperatures, a thicker coating would be appropriate.

A commercially available powder from Sulzer Metco (SM 2460) which consisted of primarily YSZ (Yttria Stabilized Zirconia) and 3% polyester was used for the top coat. A material certification of the commercially obtainable Sulzer Metco 2460NS powder is attached as Exhibit 3.

The powder was a mechanical blend that was sprayed using a standard Metco 9MB plasma spray gun. Several experimental iterations were run to obtain the desired microstructure.

In trying to optimize for high temperature regime, expected in all advanced gas turbines, both the bond coat and top coat were applied to thicknesses not normally done in the industry.

The top coat can be applied to any thickness, but to be effective both as a thermal barrier and to act as a clearance control mechanism, the thickness is typically 0.025 to 0.060 inch thick. Specific thicknesses will depend on the condition of the machine and the use temperature. For example, if the machine is new or in fairly good condition with tight clearances, a thinner bond coat and top coat may be adequate. After the parts have been in service for long periods of time, or if the clearances are wide, then thicker bond coat and top coats may be necessary. The appropriate thicknesses for the bond coat and top coat will depend on how these machines are to be operated and their prior usage history.

The drawing illustrates a typical representation of a coating applied in accordance with the above process to an inner shroud cover plate that is a preferred application using the process. The porosity level may be adjusted depending on the specific application.

The typical spray parameters using industry standard equipment are shown below. Under these conditions, powders from two vendors (Metco: SPM 2460, MetSciences 8YZRO-Poly) were deposited as coatings with the appropriate microstructure.

The MetSciences 8YZRO-Poly was a blend of an 8% yttria zirconia powder, i.e. AMPERIT 827.774 that was obtained from H. C. Starck Gmbh, and 6% of an −120+270 mesh aromatic polyester. An inspection certificate of the commercially obtainable AMPERIT 827.774 is attached as Exhibit 4.

The parameters for the spray gun used to apply the top coat were as follows:

| Primary Gas | Nitrogen |
|---|---|
| Secondary Gas | Hydrogen |
| Plasma Gun Type | 9 MB |
| Nozzle | 730 |
| Powder Port # | 2 |
| Amps | 500 |
| Volts | 77 |
| Primary (psi/fmr) | 48/75 |
| Secondary (psi/fmr) | 50/18 |
| Carrier (psi/fmr) | 40/13 |
| Powder Feed Rate (g/min) | 50 |
| Pick-Up Shaft Type | C |
| Vibrator Setting | 20 |
| Spray Distance (in.) | 4.5 |

For the bond coat, such as for the 365-2 powder, the following spray parameters have been found useful:
Bond Coat
Powder: Amdry 365-2
Gun: 9MB or 3MBT,
GP nozzle, 9MB63/3MB63 electrode
Argon/Hydrogen
Argon: 80 scfh @ 80 psi
Hydrogen: Adjust to get 68-69V @ console
Spray distance: 4-4.25″
Amps: 500
Feed rate: 35 g/min

As can be seen above, the bond coat and top coat may use similar spray guns, but the actual settings differ. Unlike the top ceramic coat, the MCrAlY bond coat may be applied via a variety of methods—these include Twin Wire Arc Spray, HVOF (High Velocity Oxy Fuel), Plasma, VPS (Vacuum Plasma Spray), or any other method whereby a suitable microstructure may be obtained. Each method has its own advantages and disadvantages, and one skilled in the art of spraying MCrAlY coatings can decipher what method may be utilized depending on the application intended for the coating.

Typically, for both bond and top coats, the powder feed rate and the relative motion between the spray gun and part is so adjusted as to give a thin lamellar coating per pass. Typically, bond coats are applied between 0.0005 to 0.002 inch per pass, and the top coat is about twice that. Desirable properties of the bond coat include:
Low oxide level
High roughness
High density

The part maybe pre-heated to about several hundred degrees Fahrenheit before applying the top coat.

Mechanical Testing: The coatings were subjected to various mechanical testing to ensure the coating had suitable attributes. The following tests conducted:
Bend Test: A 1×6″ panel was coated and bent to 180 degrees around a mandrel without the coating spalling
Tensile: Testing was carried out to ASTM C633 specification
Abradability: A flat ground specimen was coated and tested for abradability using a ceramic surface grinder. Over 0.010″ thick coating was removed in a single pass without coating spall, indicating good abradability and bonding to the bond coat.

The photomicrograph of the drawing was taken at about 200 magnification. The porosity of coatings are typically determined by comparing the structure at a given magnification with standards that have been generated with porosity levels accurately determined. This process is well known in the thermal spray industry and utilized by almost all knowledgeable about such coatings.

The invention thus provides a process that applies a single, blended powder using a single powder feeder to obtain a top coat that contains one ceramic layer.

The invention uses higher temperature resistant MCrAlY coatings than previously used and that can be used in the higher temperature turbine section of gas turbines.

The invention also provides a bond coat that is thicker; i.e. 0.007 to 0.012 inch thick, than previously used bond coats and a top coat that contains only a few percent polyester.

1. A coated substrate comprising
a substrate;
a bond coat on said substrate comprised of a high temperature MCrAlY coating of a thickness of from 0.003 inches to 0.015 inches; and
an abradable top coat on said bond coat comprised of high temperature yttria stabilized zirconia of a thickness of from 0.015 inches to 0.080 inches.

2. A coated substrate as set forth in claim 1 wherein said top coat includes a polyester in an amount of 3% to 9% by weight.

3. A coated substrate as set forth in claim 1 wherein said top coat includes a polyester in an amount of 4% to 6% by weight.

4. A coated substrate as set forth in claim 1 wherein said top coat has a thickness of from 0.025 inches to 0.060 inches.

5. A coated substrate as set forth in claim 1 wherein said bond coat is comprised of NiCoCrAlY.

6. A coated substrate as set forth in claim 1 wherein said bond coat contains a reactive element selected from the group consisting of hafnium and silicon.

7. A coated substrate as set forth in claim 1 wherein said substrate is an inner shroud cover plate.

8. A high temperature clearance coating comprising
a bond coat comprised of a high temperature MCrAlY coating of a thickness of from 0.003 inches to 0.015 inches; and
an abradable top coat on said bond coat comprised of high temperature
yttria stabilized zirconia of a thickness of from 0.015 inches to 0.080 inches.

9. A coating as set forth in claim 8 wherein said top coat includes a polyester in an amount of 3% to 9% by weight.

10. A coating as set forth in claim 8 wherein said top coat includes a polyester in an amount of 4% to 6% by weight.

11. A coating as set forth in claim 8 wherein said top coat has a thickness of from 0.025 inches to 0.060 inches.

12. A coating as set forth in claim 8 wherein said bond coat is comprised of NiCoCrAlY.

13. A coating as set forth in claim 8 wherein said bond coat contains a reactive element selected from the group consisting of hafnium and silicon.

14. A process of applying a thermal coating on a substrate comprising the steps of
spraying a high temperature MCrAlY powder onto the substrate to form a bond coat of a thickness of from 0.003 inches to 0.015 inches; and
spraying a high temperature yttria stabilized zirconia onto said bond coat to form an abradable top layer of a thickness of from 0.012 inches to 0.080 inches.

15. A process of applying a thermal coating on a substrate comprising the steps of
spraying a high temperature MCrAlY powder onto the substrate to form a bond coat of a thickness of from 0.003 inches to 0.015 inches; and
spraying a high temperature yttria stabilized zirconia directly onto said bond coat from a single powder feeder to form a single layer abradable top layer of a thickness of from 0.012 inches to 0.080 inches and with an exposed outer surface.

16. A process as set forth in claim 15 further comprising the step of adding a polyester in an amount of from 3% to 9% by weight to the high temperature MCrAlY powder.

17. A coated substrate comprising
a substrate;
a bond coat on said substrate comprised of a high temperature MCrAlY coating of a thickness of from 0.003 inches to 0.015 inches; and
an abradable single layer top coat directly on said bond coat comprised of high temperature yttria stabilized zirconia of a thickness of from 0.015 inches to 0.080 inches and having an exposed outer surface.

18. A coated substrate as set forth in claim 17 wherein said top coat includes a polyester in an amount of 4% to 6% by weight to increase porosity.
